(19) United States
(12) Patent Application Publication
(10) Pub. No.: US 2023/0031003 A1
(43) Pub. Date: Feb. 2, 2023

(54) PHONE MOUNT FOR EXERCISE MACHINE

(71) Applicant: HAIDONG GU, Pomona, CA (US)

(72) Inventor: HAIDONG GU, Pomona, CA (US)

(21) Appl. No.: 17/388,015

(22) Filed: Jul. 29, 2021

(51) Int. Cl. F16M 11/04; A63B 71/06

(52) U.S. Cl. CPC F16M 11/041; A63B 71/0619; A63B 2225/685

(57) ABSTRACT

A phone mount for an exercise machine includes a holder including a first side and a second side located opposite to the first side, and a room is defined in the first side for accommodating an electronic device. A clamp unit includes a connection section which has a first hole to which the second side of the holder is pivotably connected. The holder is pivotable relative to the handle of the exercise machine to arrange the electronic device at a desired position.

### BACKGROUND OF THE INVENTION

### 1. Fields of the Invention

The present invention relates to a phone mount for an exercise machine.

### 2. Descriptions of Related Art

When using an exercise machine, it usually spend more than 20 minutes to obtain a better result, and during the exercise period, the users may need a device for holding their smart phones. Although some of the exercise machine are equipped with a small display screen from which the users may choose different channels to watch, some users prefer to use their smart phones. The exercise machine does not provide proper support device for the smart phones.

The present invention intends to provide a phone mount that is easily secure to the handle of exercise machine, so as to position their smart phones while using the exercise machine.

### SUMMARY OF THE INVENTION

The present invention relates to a phone mount for an exercise machine, and comprises a holder including a first side and a second side which is located opposite to the first side. A room is defined in the first side and an electronic device is accommodated in the room. A clamp unit is pivotably connected to the second side of the holder. The holder is pivotable relative to the handle of the exercise machine to arrange the electronic device at a desired position.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the phone holder of the present invention;

FIG. 2 is an exploded view of the phone holder of the present invention;

FIG. 3 shows that the clamp unit of the phone holder of the present invention is to be connected to the handle of the exercise machine;

FIG. 4 shows that the clamp unit of the phone holder of the present invention is connected to the handle of the exercise machine;

FIG. 5 shows that the holder is pivoted relative to the clamp unit;

FIG. 6 shows that the charging wire passes through the first notch of the holder of the present invention;

FIG. 7 shows that a long electronic device is position to the holder;

FIG. 8 is a cross sectional view, taken along line VIII-VIII in FIG. 1;

FIG. 9 is a cross sectional view, taken along line IX-IX in FIG. 1;

FIG. 10 shows another embodiment of the phone holder of the present invention;

FIG. 11 is an exploded view of the phone holder of the present invention as disclosed in FIG. 10;

FIG. 12 shows that the clamp unit of the phone holder as disclosed in FIG. 10 is to be connected to the handle of the exercise machine;

FIG. 13 shows that the clamp unit of the phone holder as disclosed in FIG. 10 is connected to the handle of the exercise machine;

FIG. 14 shows that the holder of the present invention is pivoted relative to the link;

FIG. 15 shows that the link is pivoted relative to the clamp unit;

FIG. 16 is a cross sectional view, taken along line XVI-XVI in FIG. 10, and

FIG. 17 is a cross sectional view, taken along line XVII-XVII in FIG. 10.

### DETAILED DESCRIPTION OF THE PREFERRED EMBODIMENT

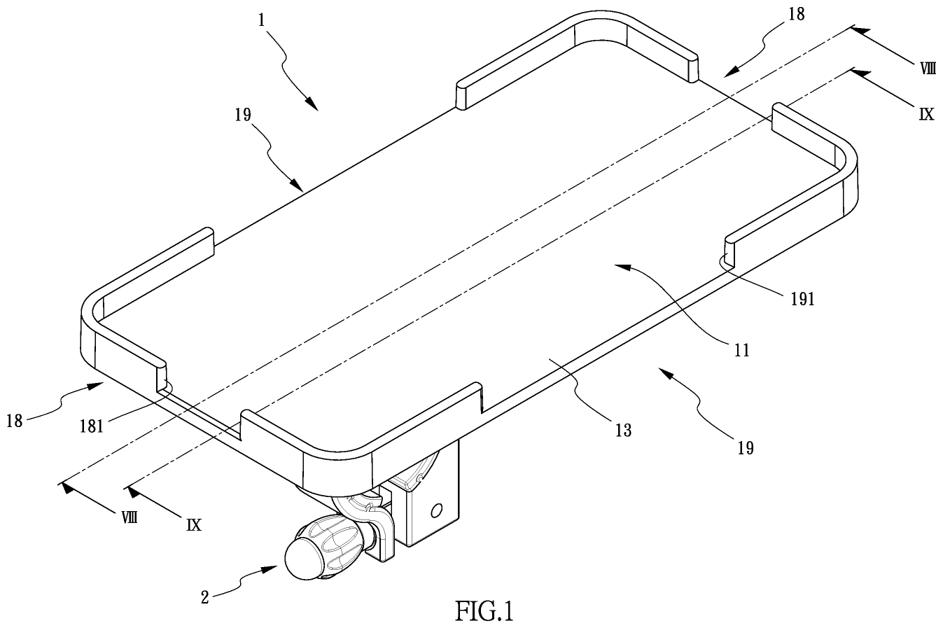

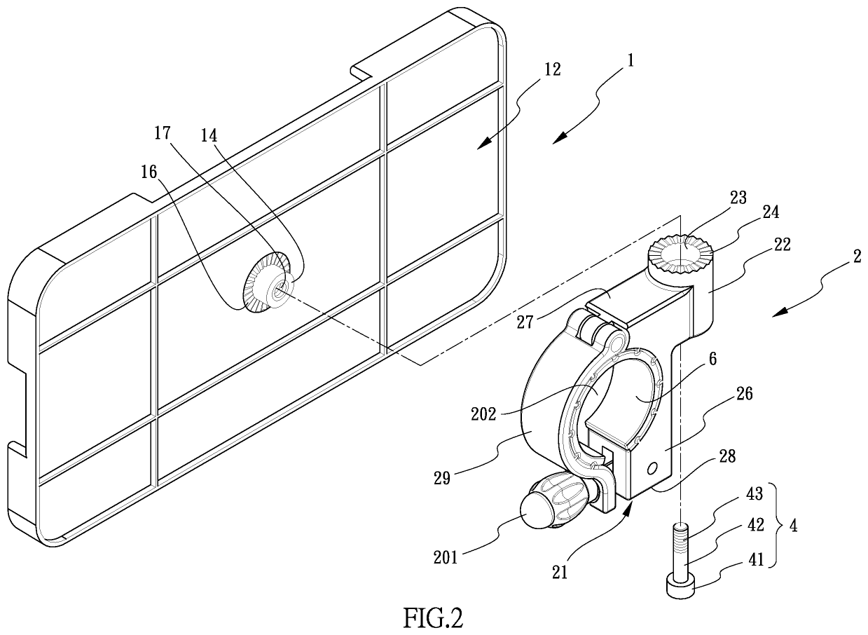

Referring to FIGS. 1 to 9, the phone mount for an exercise machine of the present invention comprises a holder 1 including a first side 11 and a second side 12 which is located opposite to the first side 11. A room 13 is defined in the first side 11, and is a recessed room 13. A clamp unit 2 is pivotably connected to the second side of the holder 1.

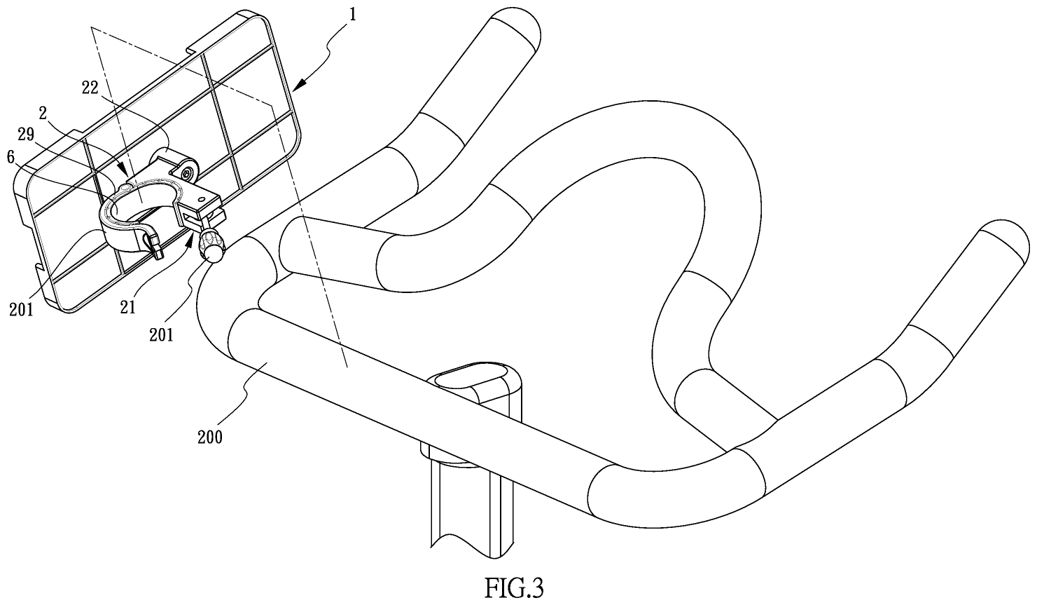

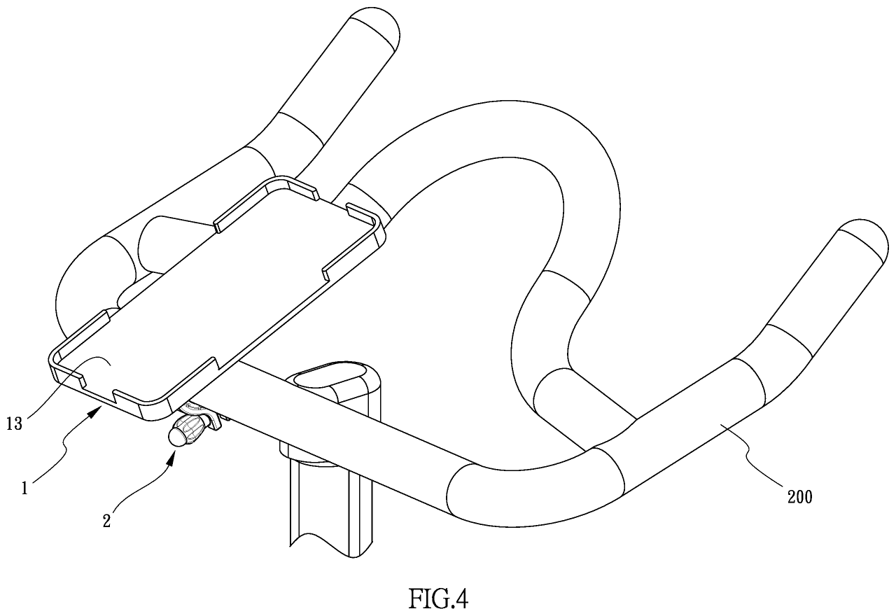

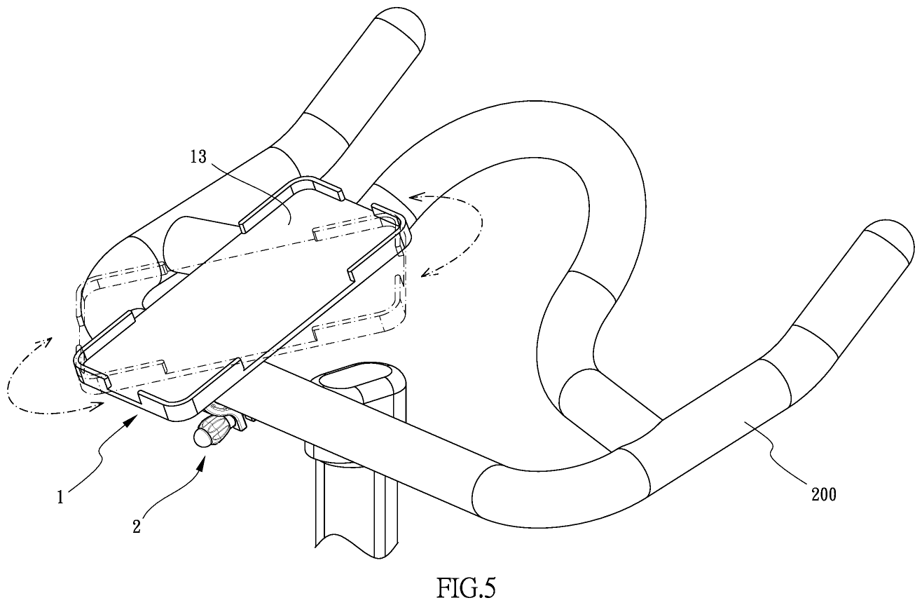

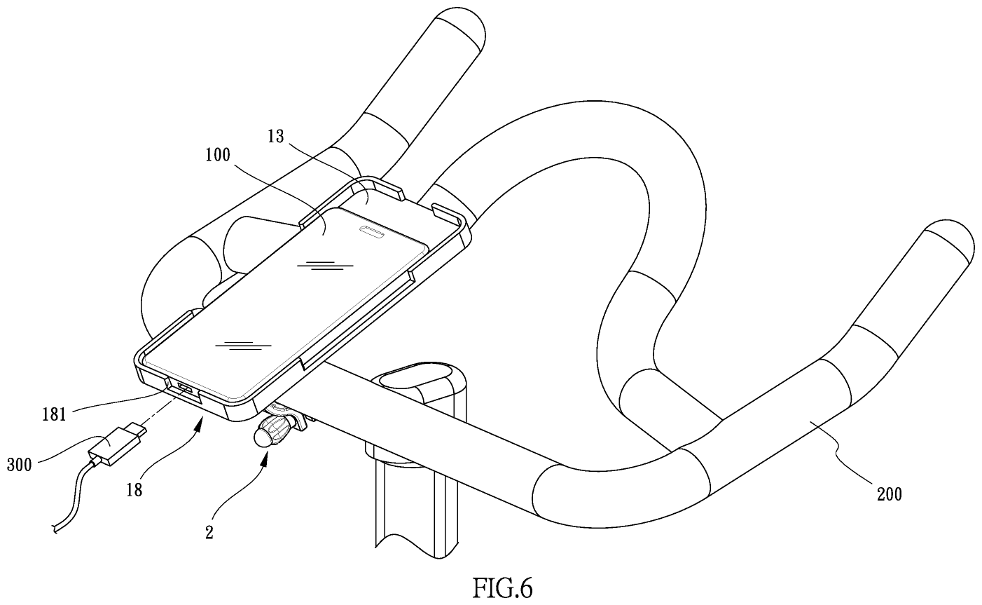

As shown in FIGS. 3 and 4, the clamp unit 2 is connected to a handle 200 of an exercise machine, and the holder 1 is able to be pivoted relative to the clamp unit 2 as shown in FIG. 5 so as to position the electronic device 100 at a desired position. As shown in FIG. 6, the electronic device 100 is a smart phone.

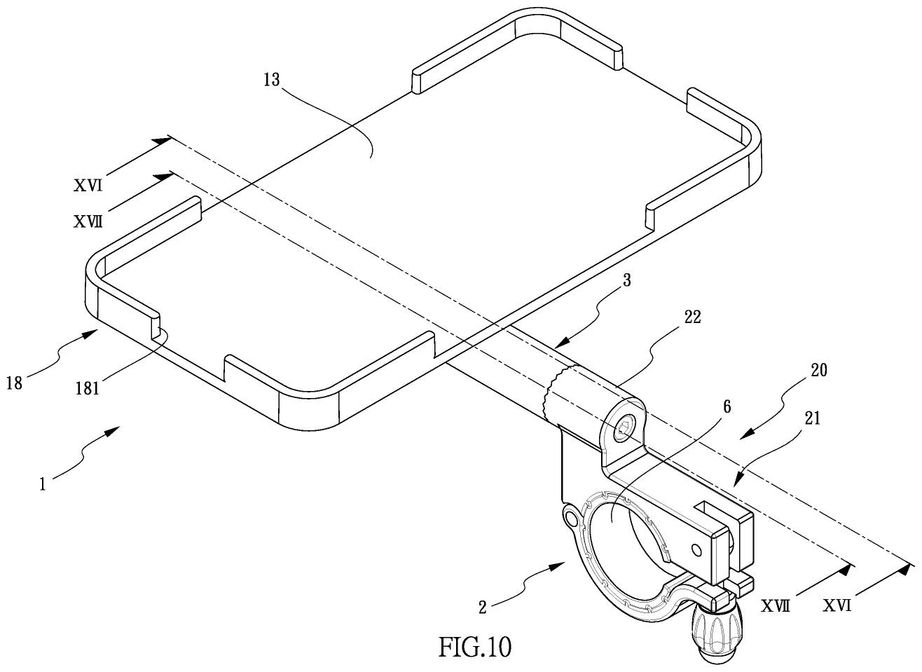

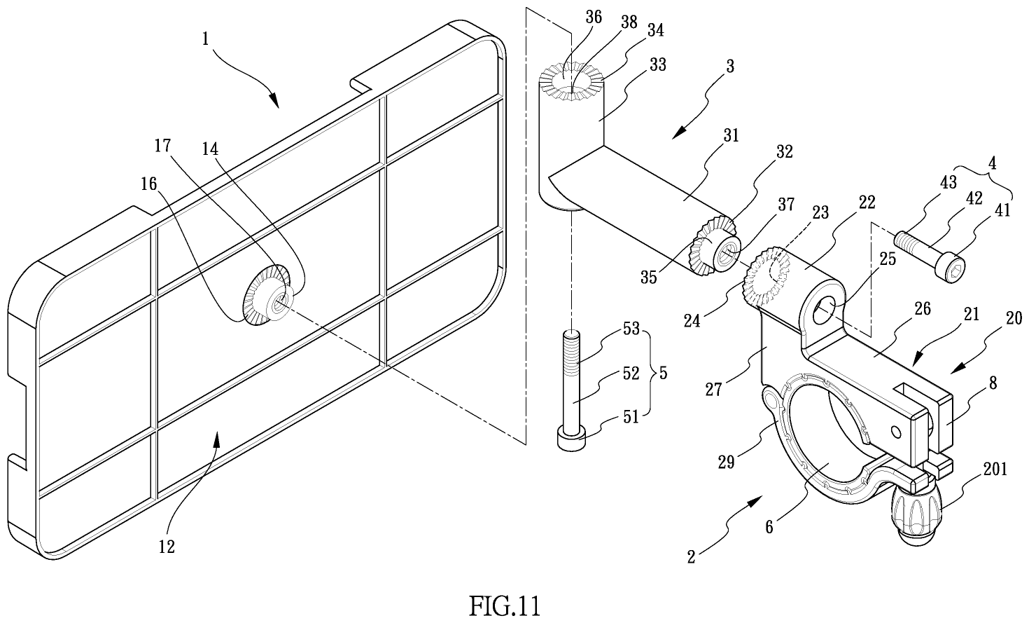

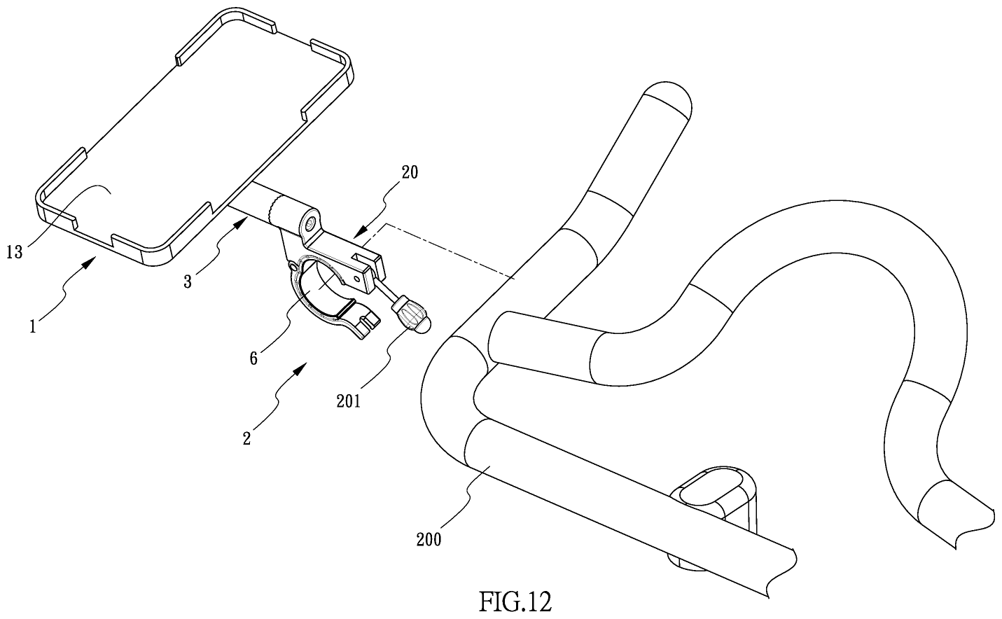

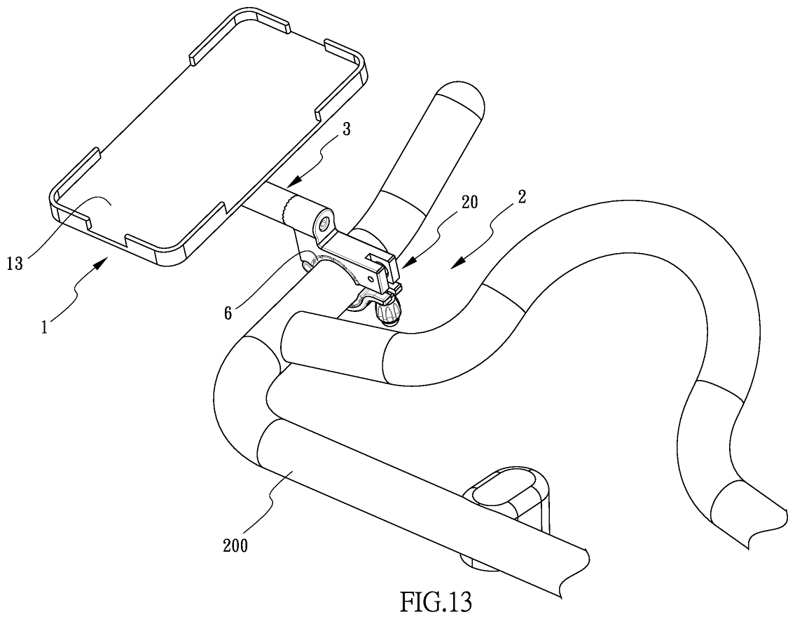

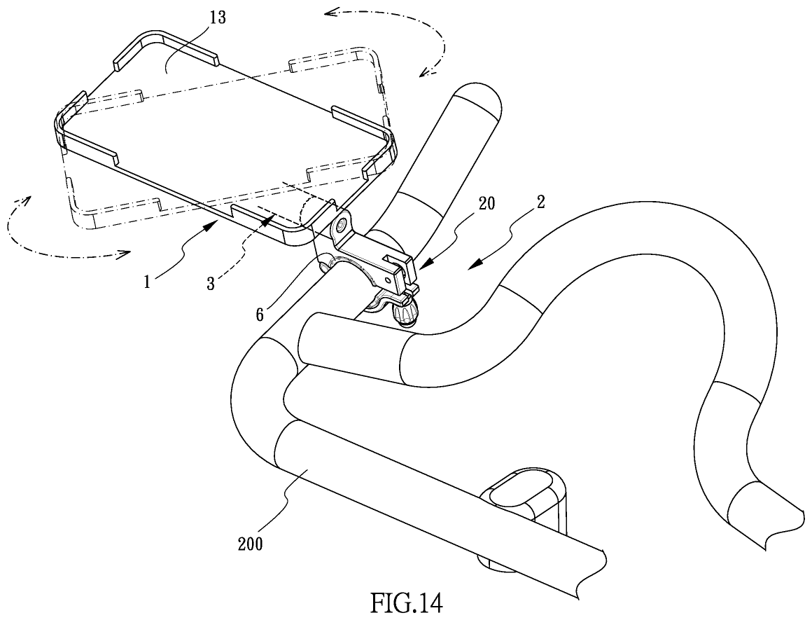

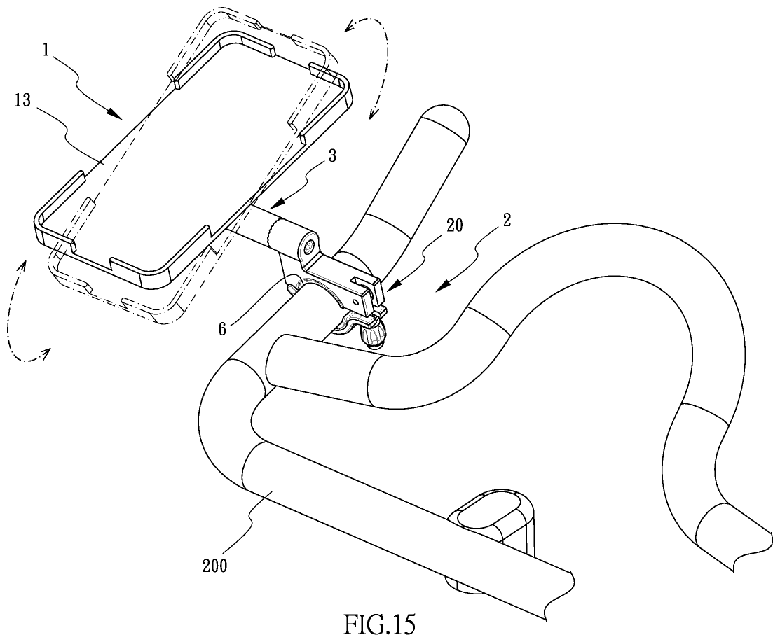

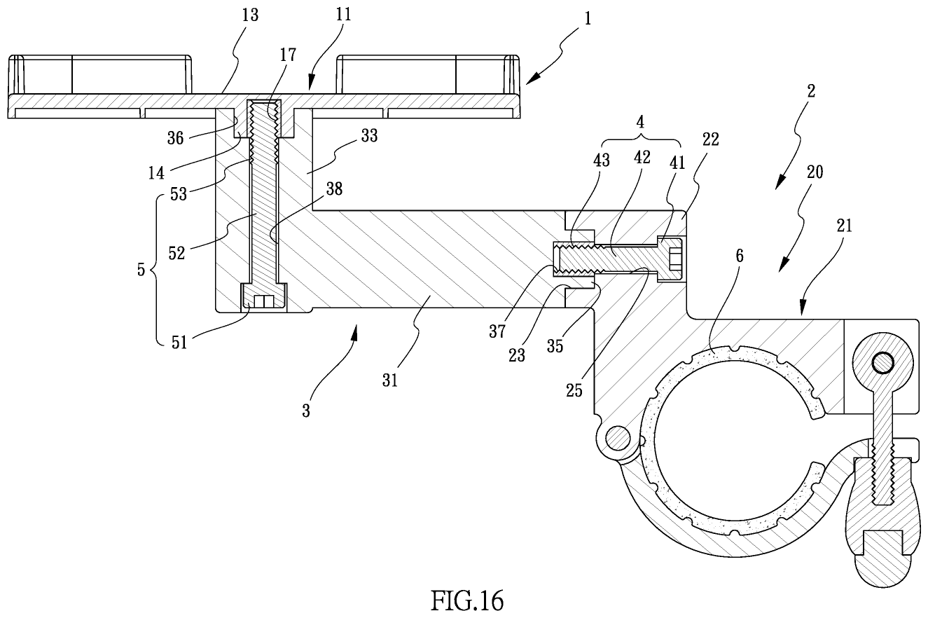

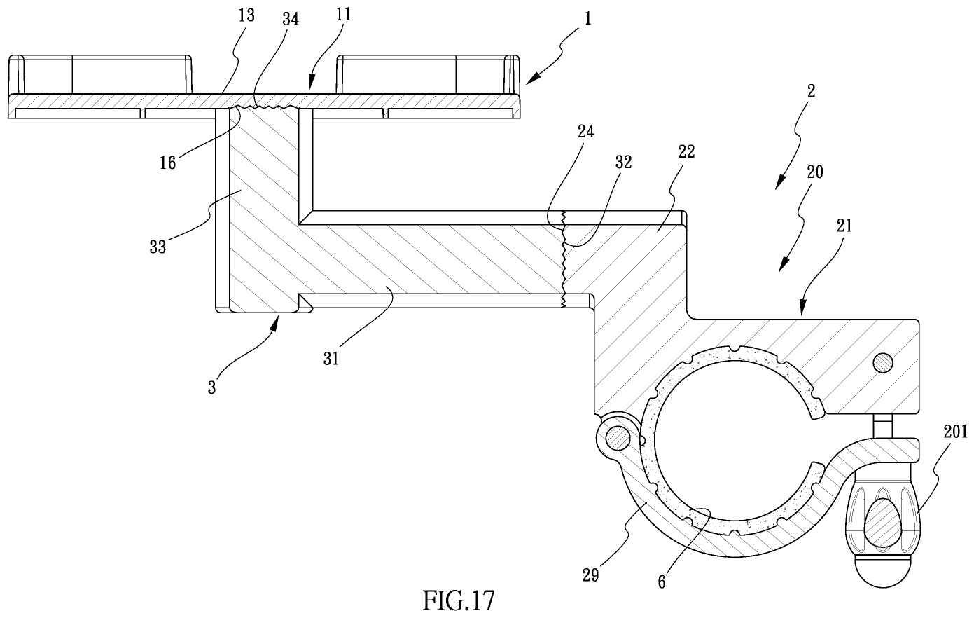

As shown in FIGS. 10 to 17, the includes a link 3 and a clamp 20, wherein the clamp 20 includes a connection section 22, and the link 3 includes a first section 31 and a second section 33 which extends at an angle from the first section 31. The first section 31 of the link 3 is pivotably connected to the connection section 22 of the clamp 20, and the second section 33 is pivotably connected to the holder 1. The link 3 allows the user to position the holder 1 at the lateral side of the handle 200 of the exercise machine.

The first section 31 of the link 3 includes a first tubular portion 35 extending axially from the first end thereof. The connection section 22 of the clamp 20 includes a first hole 23. The first tubular portion 35 is pivotably inserted into the first hole 23. The second section 33 extends from the second end of the first section 31 and includes a second hole 36. A second tubular portion 14 extends from the second side 12 of the holder 1 and is pivotably inserted into the second hole 36. Therefore, the holder 1 can be pivoted relative to the link 3, and the link 3 is pivoted relative to the clamp unit 2 so as to adjust the holder at different angular positions.

The connection section 22 includes a first toothed face 24 located around the first hole 23. The first end of the link 3 includes a second toothed face 32 located around the first tubular portion 35. The first toothed face 24 is engaged with the second toothed face 32. The second section 33 includes a third toothed face 34 located around the second hole 36. A fourth toothed face 16 is defined in the second side 12 of the holder 1 and located around the second tubular portion 14. The third toothed face 34 is engaged with the fourth toothed face 16. Therefore, the holder 1 and the link 3 are well position and do not spin.

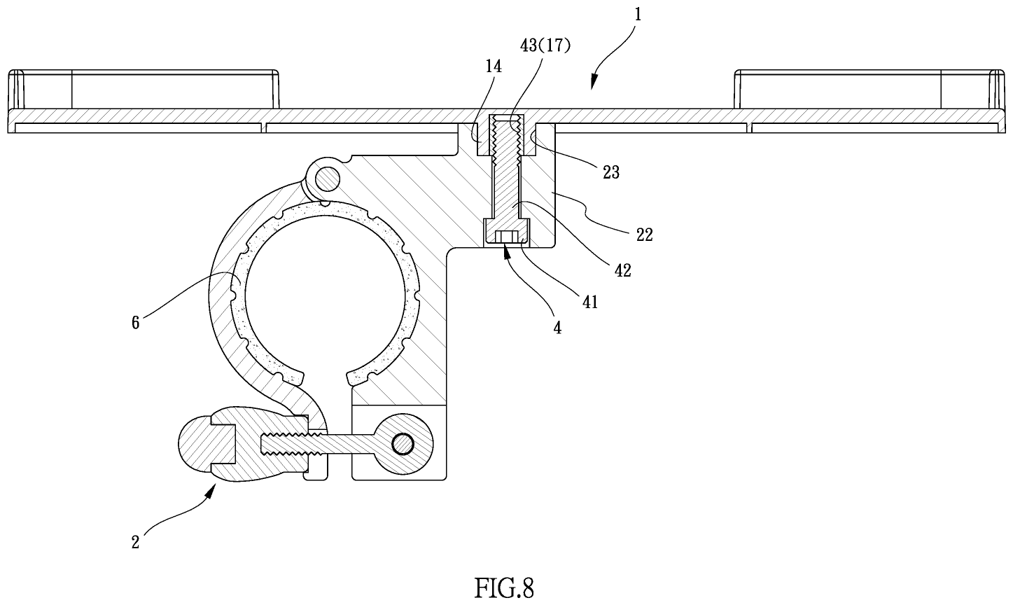

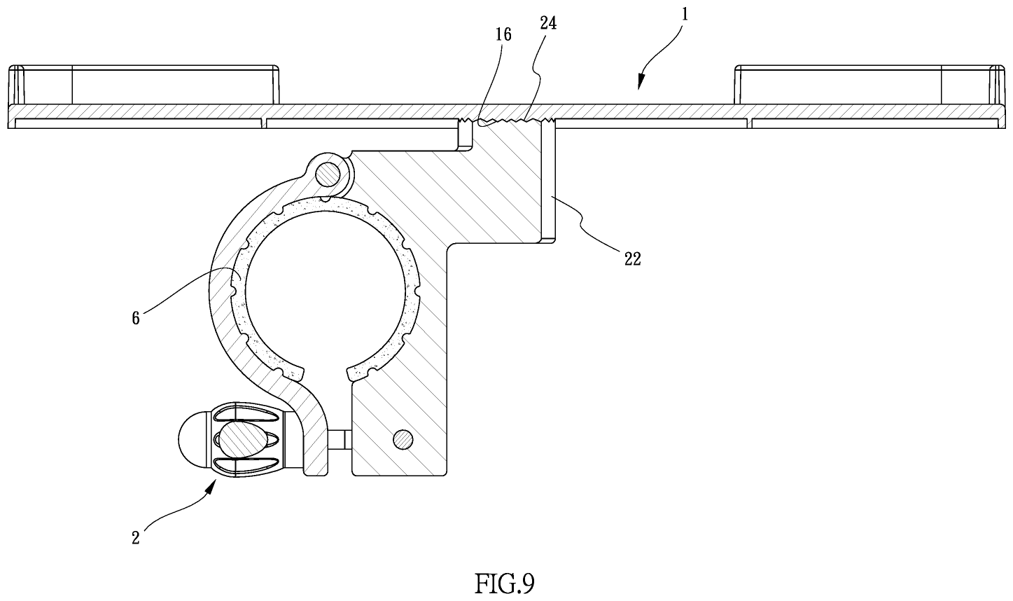

As shown in FIGS. 8 and 9, the second tubular portion 14 of holder 1 can be directly and pivotably connected to the first hole 23 without using the link 3. Specifically, the second tubular portion 14 extends from the second side 12 of the holder 1, the clamp unit 2 includes the connection section 22 which includes the first hole 23. The second tubular portion 14 is pivotably inserted into the first hole 23. The connection section 22 includes the first toothed face 24 located around the first hole 23. The fourth toothed face 16 is formed to the second side 12 of the holder 1 and located around the second tubular portion 14. The first toothed face 24 is engaged with the fourth toothed face 16.

The connection section 22 includes a first passage 25 which communicates with the first hole 23. The first tubular portion 35 includes a first threaded hole 37. The first bolt 4 includes a first head 41, a first smooth section 42 and a first threaded section 43, wherein the first smooth section 42 is formed between the first head 41 and the first threaded section 43. The first smooth section 42 of the first bolt 4 extends through the first passage 25, and the first threaded section 43 is engaged with the first threaded hole 37. The second tubular portion 14 includes a second threaded hole 17. The link 3 includes a second passage 38 which communicates with the second hole 36. A second bolt 5 includes a second head 51, a second smooth section 52 and a second threaded section 53, wherein the second smooth section 52 is formed between the second head 51 and the second threaded section 53. The second smooth section 52 of the second bolt 5 extends through the second passage 38, and the second threaded section 53 is engaged with the second threaded hole 17. The structure reinforces the connection between the link 3, the holder 1 and the clamp unit 2.

As shown in FIGS. 1 to 4, and 10 to 13, the clamp unit 2 includes a first part 21 and a second part 29. The first part 21 includes a connection section 22 and a fixed portion 26, wherein the fixed portion 26 includes a first end 27 and a second end 28. The second part 29 has the first end thereof pivotably connected to the first end 27 of the fixed portion 26. The second end of the second part 29 is connected to the second end 28 of the fixed portion 28 by a locking member 201. A space 202 is formed between the second part 29 and the fixed portion 26. Only one locking member 201 is used so that the users can easily fasten the clamp unit 2.

A flexible plate 6 is connected to two respective inner faces of the second part 29 and the fixed portion 26, and faces the space 202. The flexible plate 6 provides anti-slip feature, and also ensures that the clamp unit 2 is securely mounted to the handle 200.

As shown in FIGS. 1 and 6, the holder 1 is a rectangular holder and includes two short sides 18 and two long sides 19 which are formed between the two short sides 18. A first notch 181 is formed in each of the two short sides 18 and communicates with the room 13 so that the charging wire 300 of the electronic device 100 passes through the first notch 181.

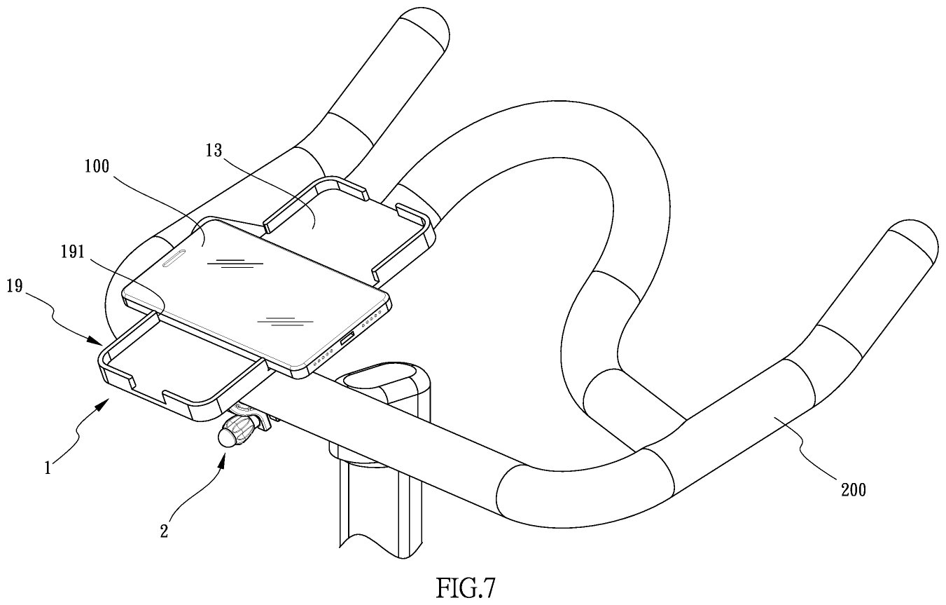

As shown in FIGS. 1 and 7, a second notch 191 is formed in each of the two long sides 19 and communicates with the room 13 so that a longer electronic device 100 can be positioned to the holder 1 by extending the electronic device 100 through the two second notches 191. The inner periphery of each of the first and second threaded holes 37, 17 is made by metal.

While we have shown and described the embodiment in accordance with the present invention, it should be clear to those skilled in the art that further embodiments may be made without departing from the scope of the present invention.

1. A phone mount for an exercise machine, comprising:
a holder including a first side and a second side which is located opposite to the first side, a room defined in the first side, and
a clamp unit pivotably connected to the second side of the holder;
wherein the clamp unit includes a first part and a second part, the first part includes a connection section and a fixed portion, the fixed portion includes a first end and a second end, the second part has a first end thereof pivotably connected to the first end of the fixed portion, a second end of the second part is connected to the second end of the fixed portion by a locking member, a space is formed between the second part and the fixed portion;
wherein a flexible plate is connected to two respective inner faces of the second part and the fixed portion, and faces the space;
wherein the two respective inner faces of the second part and the fixed portion include a plurality of arc-shaped convex portions spaced apart, and the flexible plate includes a plurality of concave portions corresponding and engaged to the plurality of convex portions.

2. The phone mount for an exercise machine as claimed in claim 1, wherein the clamp unit includes a link and a clamp, the clamp includes a connection section, the link includes a first section and a second section which extends at an angle from the first section, the first section of the link pivotably connected to the connection section of the clamp, the second section is pivotably connected to the holder.

3. The phone mount for an exercise machine as claimed in claim 2, wherein the first section of the link includes a first tubular portion extending axially from a first end thereof, the connection section of the clamp includes a first hole, the first tubular portion is pivotably inserted into the first hole, the second section extends from a second end of the first section and includes a second hole, a second tubular portion extends from the second side of the holder and is pivotably inserted into the second hole.

4. The phone mount for an exercise machine as claimed in claim 3, wherein the connection section includes a first toothed face located around the first hole, the first end of the link includes a second toothed face located around the first tubular portion, the first toothed face is engaged with the second toothed face, the second section includes a third toothed face located around the second hole, a fourth toothed face is defined in the second side of the holder and located around the second tubular portion, the third toothed face is engaged with the fourth toothed face.

5. The phone mount for an exercise machine as claimed in claim 1, wherein a second tubular portion extends from the second side of the holder, the clamp unit includes a connection section which includes a first hole, the second tubular portion is pivotably inserted into the first hole, the connection section includes a first toothed face located around the first hole, a fourth toothed face is formed to the second side of the holder and located around the second tubular portion, the first toothed face is engaged with the fourth toothed face.

6. The phone mount for an exercise machine as claimed in claim 3, wherein the connection section includes a first passage which communicates with the first hole, the first tubular portion includes a first threaded hole, a first bolt includes a first head, a first smooth section and a first threaded section, the first smooth section is formed between the first head and the first threaded section, the first smooth section of the first bolt extends through the first passage, the first threaded section is engaged with the first threaded hole, the second tubular portion includes a second threaded hole, the link includes a second passage which communicates with the second hole, a second bolt includes a second head, a second smooth section and a second threaded section, the second smooth section is formed between the second head and the second threaded section, the second smooth section of the second bolt extends through the second passage, the second threaded section is engaged with the second threaded hole.

7. (canceled)

8. (canceled)

9. The phone mount for an exercise machine as claimed in claim 1, wherein the holder includes two short sides and two long sides which are formed between the two short sides, a first notch is formed in each of the two short sides and communicates with the room.

10. The phone mount for an exercise machine as claimed in claim 1, wherein the holder includes two short sides and two long sides which are formed between the two short sides, a second notch is formed in each of the two long sides and communicates with the room.
